(19) United States
(12) Patent Application Publication
(10) Pub. No.: US 2025/0206091 A1
(43) Pub. Date: Jun. 26, 2025

(54) BIPEDAL ROBOT WITH INTEGRATED THRUSTER-ASSISTED LOCOMOTION

(71) Applicants: Northeastern University, Boston, MA (US); California Institute of Technology, Pasadena, CA (US)

(72) Inventors: Shreyansh Pitroda, Boston, MA (US); Alireza Ramezani, Bridgewater, MA (US); Morteza Gharib, Altadena, CA (US)

(21) Appl. No.: 18/999,160

(22) Filed: Dec. 23, 2024

Related U.S. Application Data
(60) Provisional application No. 63/613,933, filed on Dec. 22, 2023.

(51) Int. Cl. B60F 5/02; B62D 57/032; B64C 25/50; B64C 25/58; B64C 37/00

(52) U.S. Cl. CPC B60F 5/02; B62D 57/032; B64C 25/50; B64C 37/00; B64C 25/58

(57) ABSTRACT

A bipedal robot having a legged assembly and an aerial assembly is described. The legged assembly includes two legs, each leg having a hip frontal joint, a hip sagittal joint, and a knee joint. The aerial assembly includes two thrusters mounted on a carbon fiber-aluminum composite mount. Actuators for the joints include 3D printed housings with embedded components. A controller generates walking trajectories and controls the thrusters to assist with stabilization and obstacle traversal. The robot is capable of dynamic multimodal locomotion, combining legged movement with thruster-assisted stabilization and jumping to navigate challenging terrain.

### CROSS-REFERENCE TO RELATED APPLICATIONS

This application claims priority to U.S. Application No. 63/613,933, titled DYNAMIC GROUND AND AERIAL LOCOMOTION, filed Dec. 22, 2023, the contents of which are incorporated by reference in their entirety.

### FIELD OF INVENTION

The present disclosure relates to bipedal robots with integrated aerial propulsion capabilities, and more particularly to a bipedal robot with thruster-assisted locomotion for enhanced stability and obstacle traversal in challenging environments.

### BACKGROUND

Bipedal robots have been developed to mimic human-like locomotion and navigate challenging terrains. These robots can access areas with narrow passages, climb stairs, and perform agile maneuvers. However, even the most advanced bipedal systems face limitations in recovering from slips or disturbances beyond certain thresholds, particularly in uncertain outdoor environments with uneven terrain.

Recent advancements in robotics have explored the integration of aerial propulsion elements with legged locomotion. This approach aims to enhance stability, maneuverability, and obstacle traversal capabilities. However, existing hybrid ground-aerial robots often struggle to achieve seamless coordination between legged movements and thruster assistance, limiting their effectiveness in complex real-world scenarios that require dynamic multimodal locomotion.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present invention provides a bipedal robot with enhanced mobility and stability through the integration of legged locomotion and aerial propulsion. This innovative design enables the robot to navigate challenging terrains, overcome obstacles, and maintain balance in various environments. The robot has potential applications in search and rescue operations, military surveillance, space exploration, and civic package delivery in residential areas.

In a first aspect, a bipedal robot is provided. The robot includes a legged assembly, with each leg having a hip frontal joint, a hip sagittal joint, and a knee joint. An aerial assembly comprising two thrusters mounted on a composite mount is integrated into the robot's structure. The robot features actuators for the joints, which include 3D printed housings with embedded components. A controller generates walking trajectories and controls the thrusters to assist with stabilization and obstacle traversal.

In some embodiments of the first aspect, the composite mount comprises a carbon fiber-aluminum composite plate, providing a lightweight yet strong structure for the thruster assembly. Each leg may further include an ankle joint with a shock absorber assembly, enhancing the robot's ability to absorb impact forces during locomotion. The shock absorber assembly may comprise a spring, a nut, and a housing reinforced with Kevlar for improved durability and impact resistance.

In some implementations, the actuators comprise a motor assembly including a brushless DC motor and an encoder, as well as a harmonic drive assembly. The 3D printed housings of the actuators may include embedded bearings and heat-set inserts, allowing for a compact and efficient design. The controller may implement a capture point algorithm to generate foot placement coordinates based on pitch and roll angles of the robot, enabling dynamic stability control.

In a second aspect, a method of operating a bipedal robot is provided. The method includes generating walking trajectories for each leg of the robot, where each leg has a hip frontal joint, a hip sagittal joint, and a knee joint. The method involves actuating the joints using actuators with 3D printed housings and embedded components, and controlling two thrusters mounted on a composite mount to assist with stabilization and obstacle traversal.

In some embodiments of the second aspect, the method includes generating capture point coordinates based on pitch and roll angles of the robot and adjusting foot placement of the legs based on these coordinates. The method may involve filtering inertial measurement unit data to obtain the pitch and roll angles, and generating the capture point coordinates when the pitch or roll angles exceed a predetermined threshold.

In some implementations, the method includes generating bezier curves to define trajectories for the hip frontal joint, hip sagittal joint, and knee joint of each leg. This may involve defining control points for start and end positions of each joint trajectory and calculating intermediate points to create smooth transitions between joint positions. The method may also include activating shock absorbers in ankle joints of the legs to absorb impact forces during locomotion, which can involve compressing springs within housings reinforced with Kevlar and adjusting compression of the springs using threaded nuts to modify shock absorption characteristics.

In a third aspect, a control system for a bipedal robot is provided. The control system includes a processor executing instructions to generate walking trajectories for each leg of the robot, control actuators with 3D printed housings and embedded components to move the joints according to the walking trajectories, and control two thrusters mounted on a composite mount to assist with stabilization and obstacle traversal.

In some embodiments of the third aspect, the processor executes instructions to generate capture point coordinates based on pitch and roll angles of the robot and adjust foot placement of the legs based on these coordinates. The processor may filter inertial measurement unit data to obtain the pitch and roll angles and generate the capture point coordinates when the pitch or roll angles exceed a predetermined threshold.

In some implementations, the processor executes instructions to generate bezier curves defining trajectories for the hip frontal joint, hip sagittal joint, and knee joint of each leg. This may involve defining control points for start and end positions of each joint trajectory and calculating intermediate points to create smooth transitions between joint positions. The processor may also execute instructions to activate shock absorbers in ankle joints of the legs to absorb impact forces during locomotion by compressing springs within housings reinforced with Kevlar and adjust compression of the springs using threaded nuts to modify shock absorption characteristics.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a perspective view of a bipedal robot, according to aspects of the present disclosure.

FIG. 1B illustrates three operational modes of the bipedal robot of FIG. 1A, according to an embodiment.

FIG. 2 illustrates a perspective view of the bipedal robot with detailed inset views, according to aspects of the present disclosure.

FIG. 3 illustrates a sectional view of a knee joint of the bipedal robot, according to an embodiment.

FIG. 4 illustrates an isometric view of a thruster assembly of the bipedal robot, according to aspects of the present disclosure.

FIG. 5 illustrates a perspective view of an ankle joint assembly of the bipedal robot, according to an embodiment.

FIG. 6 illustrates a control system diagram of the bipedal robot, according to aspects of the present disclosure.

FIG. 7 illustrates a kinematic diagram of a robotic leg system, according to an embodiment.

FIG. 8 illustrates time-series graphs of left leg joint angles, according to aspects of the present disclosure.

FIG. 9 illustrates time-series graphs of right leg joint angles, according to an embodiment.

FIG. 10 illustrates time-series graphs of vertical body position and thruster forces, according to aspects of the present disclosure.

FIG. 11 illustrates time-series graphs of ground reaction forces, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

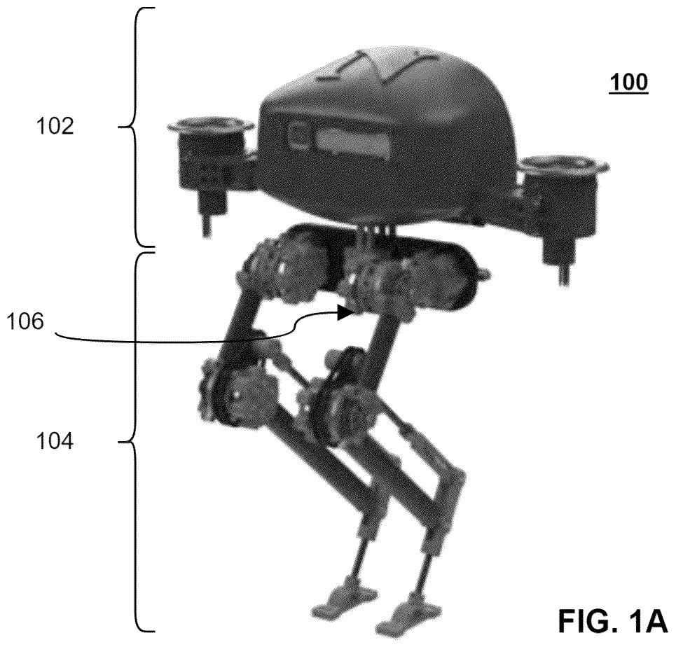

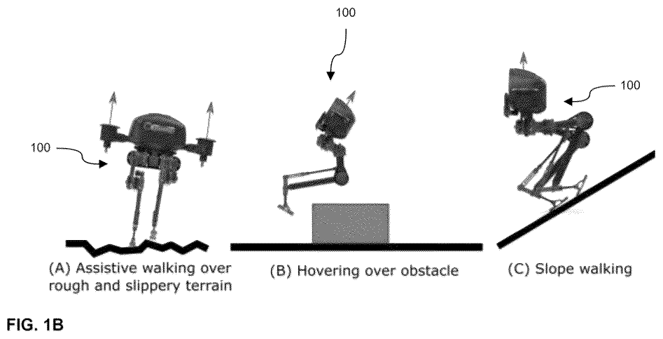

FIG. 1A illustrates a bipedal robot 100. The bipedal robot 100 may comprise a thruster assembly 102, a leg assembly 104, and a pelvis block assembly 106.

The leg assembly 104 may include two legs, with each leg having a hip frontal joint, a hip sagittal joint, and a knee joint. These joints may enable the bipedal robot 100 to perform walking motions by articulating the legs in a coordinated manner. Although shown as a bipedal robot in FIG. 1A, a different number of legs may be provided by leg assembly 104, such as three legs, four legs, six legs or eight legs.

The thruster assembly 102 may be positioned at the upper portion of the bipedal robot 100. In some cases, the thruster assembly 102 may include two thrusters mounted on a composite mount. The thrusters may provide vertical thrust and assist with stabilization during locomotion. Although shown the thruster assembly shown FIG. 1A provides two thrusters, a different number of thrusters may be provided by the thruster assembly 102, such as three thrusters, four thrusters, six thrusters or eight thrusters.

The pelvis block assembly 106 may connect the thruster assembly 102 to the leg assembly 104. The pelvis block assembly 106 may contain components for coordinating movement between the upper and lower portions of the bipedal robot 100.

In some cases, the bipedal robot 100 may include a controller. The controller may generate walking trajectories for the leg assembly 104. Additionally, the controller may control the thrusters in the thruster assembly 102 to assist with stabilization and obstacle traversal.

The combination of the leg assembly 104 and the thruster assembly 102 may enable the bipedal robot 100 to perform both walking and flying movements. This dual capability may allow the bipedal robot 100 to navigate complex environments and overcome obstacles that may be challenging for traditional bipedal robots.

FIG. 1B illustrates three operational modes of the bipedal robot 100, demonstrating the robot's versatility in navigating various terrains and obstacles.

In some cases, the bipedal robot 100 may perform assistive walking over rough and slippery terrain, as shown in view (A) of FIG. 1B. During this mode, the leg assembly may navigate uneven surfaces while the thruster assembly provides additional stability. The thrusters may generate upward force to reduce the effective weight of the bipedal robot 100, allowing for more precise foot placement and reducing the risk of slipping.

In some cases, the bipedal robot 100 may hover over obstacles, as depicted in view (B) of FIG. 1B. In this mode, the thruster assembly may generate sufficient upward thrust to lift the bipedal robot 100 off the ground, while the leg assembly may be positioned to clear the obstruction. This capability may allow the bipedal robot 100 to traverse obstacles that would be challenging or impossible to navigate using only the leg assembly.

In some cases, the bipedal robot 100 may perform slope walking, as illustrated in view (C) of FIG. 1B. During slope walking, the leg assembly may execute walking motions on an inclined surface while the thruster assembly assists in maintaining balance. The thrusters may generate thrust vectors that counteract the gravitational force acting on the bipedal robot 100, reducing the load on the leg assembly and improving stability on steep inclines.

In some cases, the bipedal robot 100 may utilize a capture point algorithm to enhance stability during these operational modes. The capture point algorithm may generate foot placement coordinates based on the pitch and roll angles of the bipedal robot 100. These coordinates may be used to adjust the foot placement of the leg assembly, allowing the bipedal robot 100 to maintain balance and stability in challenging terrain.

The thruster assembly and the leg assembly may work together in each scenario to provide enhanced mobility and stability. The thrusters may provide additional force to complement the actions of the leg assembly, allowing the bipedal robot 100 to adapt to various environmental conditions and overcome obstacles that may be challenging for traditional bipedal robots.

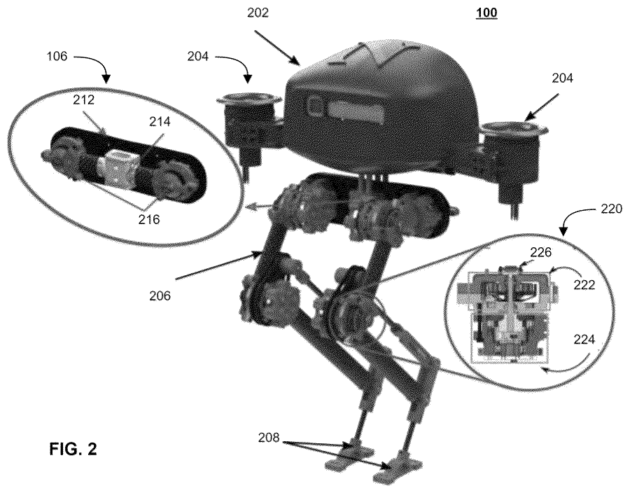

FIG. 2 illustrates a detailed view of the bipedal robot 100. The bipedal robot 100 may include a dome 202 at its upper portion. As shown in FIG. 2, two thrusters 204 are mounted on opposite sides of the dome 202. The thrusters 204 may be positioned to provide vertical thrust and stability control as part of the thruster assembly 102.

Still referring to FIG. 2. and in greater detail, the dome 202 may be constructed from lightweight materials such as carbon fiber or reinforced polymers to minimize additional weight while providing structural integrity. The dome 202 may feature ventilation openings or channels to manage airflow and heat dissipation from the thrusters 204 during operation.

In some aspects, the dome 202 may incorporate mounting points or brackets to which thrusters 204 may securely attach. The dome 202 may also include integrated wiring channels or conduits to route power and control cables to the thrusters 204, enhancing the overall organization and protection of the electrical systems.

The shape of the dome 202 may be designed to optimize aerodynamics and reduce air resistance during both walking and flying modes of operation. In some cases, the dome 202 may feature a modular design, allowing for easy access to internal components for maintenance or upgrades.

The thruster assembly 102 may be mounted on a composite mount. In some cases, the composite mount may comprise a carbon fiber-aluminum composite plate. This material choice may provide a high strength-to-weight ratio, contributing to the overall efficiency and performance of the bipedal robot 100.

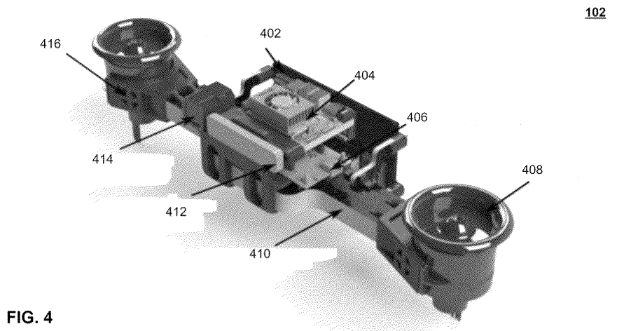

Referring ahead to FIG. 4, and in brief overview, an isometric view of one embodiment of thruster assembly 102 is shown comprising several components arranged in a linear configuration along a mounting plate 410. As shown in FIG. 4, the thruster assembly 102 may include an amplifier rack 402, AI processor 404, processor 406, fan 408, mounting plate 410, camera 412, thermal camera 414, and fan mount 416.

Still referring to FIG. 4, and in greater detail, the amplifier rack 402 may be connected to an Al processor 404 and a processor 406. The amplifier rack 402 may control the power distribution to various components of the thruster assembly 102.

In some cases, the AI processor 404 is provided as an STM(F439ZI)+NetXshield board (STMicroelectronics NV, Geneva, Switzerland). In other embodiments, AI processor 404 is provided as an Arduino Due (Arduino, S.R.L.), Raspberry Pi 4 (Raspberry PI Holdings, plc), BeagleBone Black (the Beagleboard.org Foundation, Michigan) or Jetson Nano (NVIDIA Corp., Santa Clara, California). The AI processor 404 may process data from sensors and cameras to assist with navigation and obstacle detection.

The processor 406 may manage the overall operations of the thruster assembly 102, including coordinating with the leg assembly 104 for balanced locomotion. In some embodiments, processor 406 is provided as a Jetson Orin processor (NVIDIA Corp., Santa Clara, California), which may provide advanced computing capabilities for real-time decision making and control. Alternative processors to the Jetson Orin may include the Intel NUC (Intel Corporation, Santa Clara, California), the Qualcomm Robotics RB5 Platform (Qualcomm Technologies, Inc., San Diego, California), the Xilinx Zynq UltraScale+ MPSoC (Advanced Micro Devices, Inc., Santa Clara, California), the Texas Instruments AM65x Processor (Texas Instruments Incorporated, Dallas, Texas), and the NXP i.MX 8 Series (NXP Semiconductors N.V., Eindhoven, Netherlands).

As shown in FIG. 4, the thruster assembly 102 may include fans 408 housed in fan mounts 416. The fans 408 may be positioned at each end of the mounting plate 410. In other embodiments, the fans 408 may be integrated directly into the dome 202 structure in addition to, or as an alternative to, mounting at the end of the mounting plate 410. In some other embodiments, the thruster assembly 102 may incorporate multiple smaller fans distributed throughout the structure, rather than relying on two larger fans at the ends. This distributed approach may provide more thrust control across the entire assembly. Alternatively, the fans 408 may be mounted on adjustable brackets, allowing their position and orientation to be modified based on specific thrust requirements.

In still other embodiments, the thruster assembly 102 may utilize a combination of fixed and movable fans 408. For instance, some fans 408 may be permanently mounted at strategic locations, while others may be attached to servo motors, allowing them to dynamically adjust their position and airflow direction based on real-time monitoring.

Fans 408 may provide the primary thrust for the bipedal robot 100 during flying operations, allowing for vertical takeoff and landing capabilities. Fans 408 may be provided as propellers, jet engines, turbofans, axial fans, centrifugal fans, mixed-flow fans, cross-flow fans, piezoelectric fans, ionic thrusters, magnetohydrodynamic drives or electric ducted fans. In some specific embodiments, the thruster assembly 102 employs Schuebeler DS-38 AXI HDS (Schuebeler Technologies GmbH, Bad Lippspringe, Germany). In some embodiments, the thruster assembly 102 may utilize a Castle Creations Phoenix Edge 100 ESC (Electronic Speed Controller) (Castle Creations, Inc., headquartered in Olathe, Kansas) to control the speed and power output of the thrusters 408, enabling smooth and responsive flight control.

In some implementations, the thruster assembly 102 may include a camera 412 and a thermal camera 414 to enhance the bipedal robot's sensing capabilities. The camera 412 may be a high-resolution digital camera capable of capturing visual data in various lighting conditions. This camera may assist in object recognition, obstacle detection, and environmental mapping. The thermal camera 414 may be used to detect heat signatures, which may be particularly useful for identifying living beings or heat-emitting objects in low-light or visually obstructed environments. In some cases, the cameras may be mounted on adjustable gimbals to allow for a wider field of view and dynamic repositioning during different operational modes. The data from these cameras may be processed by the AI processor 404 to provide real-time information for navigation, obstacle avoidance, and decision-making algorithms.

In some cases, the mounting plate 410 may be constructed from a 1-inch thick carbon fiber-aluminum composite plate. This material choice may provide a high strength-to-weight ratio, contributing to the overall efficiency of the bipedal robot 100. The arrangement of these components on the mounting plate 410 may provide balanced weight distribution and efficient cooling through the integrated fans 408. This configuration may enable the thruster assembly 102 to work in conjunction with the leg assembly 104, enhancing the bipedal robot 100's ability to navigate complex environments through both walking and flying modes.

Referring back to FIG. 2, bipedal robot 100 includes a pelvis block assembly 106 connecting the upper and lower portions of the bipedal robot 100. In some cases, as shown in FIG. 2, the pelvis block assembly 106 may include a carbon fiber plate 212. The carbon fiber plate 212 may have an embedded mount 214 and an embedded actuator assembly 216. In some specific cases, the pelvis block assembly 106 may include two carbon fiber plates placed 8 mm apart. This configuration may provide additional stability and support for the bipedal robot 100.

The leg assembly 104 may comprise carbon fiber rods 206 extending downward from the pelvis block assembly 106. The carbon fiber rods 206 may terminate in feet 208. In some cases, the carbon fiber rods 206 may have an oval cross-section. The oval cross-section may optimize the balance between stiffness, strength, and weight within the leg structure.

The leg assembly 104 may incorporate multiple joints, including a knee joint 220. The knee joint 220 may be detailed in an inset view showing its internal components. The knee joint 220 assembly may consist of a motor assembly 222 and a harmonic drive assembly 224. An encoder 226 may be included for position sensing and control. This configuration may enable precise control of leg movements while maintaining a lightweight structure.

In some cases, the bipedal robot 100 may have actuators for the joints. The actuators may include 3D printed housings with embedded components. This design approach may allow for customized, lightweight actuator housings that integrate seamlessly with other components of the bipedal robot 100.

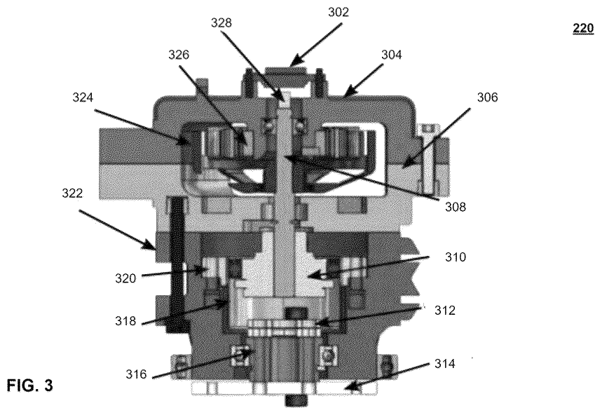

Referring ahead to FIG. 3, a sectional view of knee joint 220 is shown, depicting internal components and their arrangement. The knee joint 220 may comprise a motor assembly 222 in the upper portion and a harmonic drive assembly 224 in the lower portion.

The upper portion of the knee joint 220 may include a first relative encoder 302 mounted at the top, followed by a top motor housing 304 and a bottom motor housing 306. A second relative encoder 308 may be positioned between the top motor housing 304 and the bottom motor housing 306. In some cases, the first relative encoder 302 and the second relative encoder 308 may be RMB20 encoder modules (Renishaw plc, Wotton-under-Edge, Gloucestershire, United Kingdom). The motor assembly may contain a rotor 324 and a stator 326, with a magnet 328 positioned between the rotor 324 and the stator 326. In some cases, the motor assembly may include a brushless DC motor, such as a T-motor Antigravity 4006 motor. The brushless DC motor may provide high torque and efficient operation for actuating the knee joint 220.

The lower portion of the knee joint 220 may contain the harmonic drive components. A wave generator 310 may be connected to an outer shaft connector 312. A flex spine 318 and a circular spline 320 may be housed within a harmonic housing 322. In some cases, the harmonic drive assembly may use a CSF-11-30-2A-R harmonic drive (Harmonic Drive LLC, headquartered in Peabody, Massachusetts). The harmonic drive may provide high gear reduction and precise motion control.

An output shaft 316 may extend from the bottom of the assembly and connect to a leg connector 314. The input shaft, output shaft 316, output flange, and flex spline clamp ring may be machined from 316 stainless steel to ensure precision and durability.

The 3D printed housings of the actuators in the bipedal robot 100 may comprise embedded bearings and heat-set inserts. This design approach may allow for a compact and integrated structure while maintaining the necessary strength and precision for the knee joint 220 operation.

The arrangement of these components in the knee joint 220 may enable precise rotational control and power transmission. The dual encoder configuration with the first relative encoder 302 and the second relative encoder 308 may allow for accurate position sensing at different stages of the power transmission. The motor assembly may generate the initial rotational motion, which may then be transmitted through the harmonic drive assembly. The harmonic drive assembly may provide gear reduction and torque multiplication, allowing for precise and powerful movements of the knee joint 220.

In some cases, the combination of the brushless DC motor and the harmonic drive assembly may provide a high power-to-weight ratio, contributing to the overall efficiency and performance of the leg assembly 104 in the bipedal robot 100. The precise control enabled by this actuator design may allow the bipedal robot 100 to perform complex walking motions and maintain stability in various terrains.

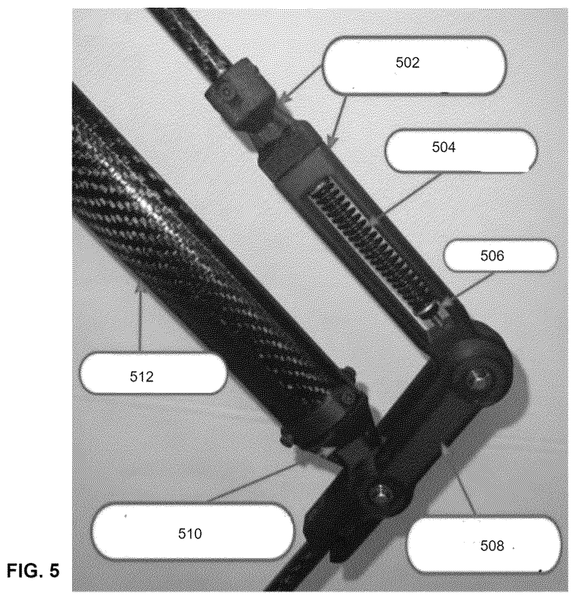

FIG. 5 illustrates a perspective view of an ankle joint assembly of the bipedal robot 100. The ankle joint assembly may comprise several components arranged to enable controlled movement and shock absorption at the ankle joint.

The ankle joint assembly may include a housing 502 positioned at the upper portion of the assembly. The housing 502 may provide structural support for the internal components. In some cases, the housing 502 may be reinforced with Kevlar to enhance its strength and durability.

A spring 504 may be installed below the housing 502 to provide shock absorption capabilities. In some cases, the spring 504 may be a LHL 375AB spring. Alternative springs that may be used in place of the LHL 375AB spring include coil springs, leaf springs, torsion springs, gas springs, air springs, elastomeric springs, wave springs, Belleville springs, or custom-designed composite springs. The spring 504 may interface with a nut 506 that allows for adjustment of spring tension. The nut 506 may be threaded, enabling fine-tuning of the compression of the spring 504. This adjustability may allow for modification of the shock absorption characteristics of the ankle joint assembly.

The ankle joint assembly may include an ankle assembly 508 positioned at the lower end of the structure. The ankle assembly 508 may serve as the connection point for the fect 208 of the bipedal robot 100. A knee to ankle connector 510 may join the upper and lower portions of the leg structure. The knee link 512, which may be constructed from carbon fiber, may extend upward from the joint assembly and connect to the knee joint 220.

In some cases, the ankle joint assembly may function as a shock absorber to absorb impact forces during locomotion of the bipedal robot 100. The shock absorption may be achieved by compressing the spring 504 within the housing 502. The Kevlar reinforcement of the housing 502 may allow it to withstand the forces generated during compression of the spring 504.

The components of the ankle joint assembly may be arranged to create an articulated joint that enables controlled movement while providing shock absorption through the spring 504 and nut 506 assembly. The design may integrate rigid structural elements with flexible components to balance stability and adaptability in the leg assembly 104 of the bipedal robot 100

In some cases, the shock absorption characteristics of the ankle joint assembly may be modified by adjusting the compression of the spring 504 using the threaded nut 506. This adjustability may allow the bipedal robot 100 to adapt to different terrains or locomotion modes by altering the stiffness of the ankle joint.

The ankle joint assembly may work in conjunction with the other components of the leg assembly 104, such as the knee joint 220, to provide a full range of motion for the bipedal robot 100. The combination of controlled movement and shock absorption in the ankle joint assembly may contribute to the overall stability and adaptability of the bipedal robot 100 during various types of locomotion, including walking on uneven terrain or landing after a jump assisted by the thruster assembly 102.

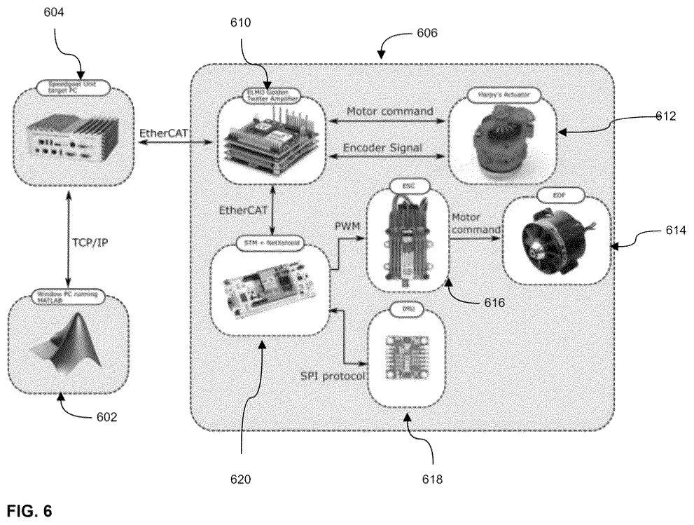

FIG. 6 illustrates a control system diagram showing the communication and control architecture of the bipedal robot 100. The control system may include an external PC 602, a low-level controller 604, a high-level controller 606, and various subsystems that work together to control the bipedal robot 100's movements.

In some cases, the external PC 602 may run MATLAB software (Math Works, Natick, Massachusetts) and communicate with the low-level controller 604 via TCP/IP protocol. The external PC 602 may be used for high-level planning, trajectory generation, and user interface functions.

The low-level controller 604 may interface through EtherCAT with the high-level controller 606. In some cases, the low-level controller 604 may be implemented using a Speedgoat real-time processor (Speedgoat GmbH, Liebefeld, Switzerland). The low-level controller 604 may handle tasks such as real-time control loops, sensor data processing, and communication with the motor drivers 610.

The high-level controller 606 may manage various subsystems of the bipedal robot 100. The high-level controller 606 may contain motor drivers 610 that send motor commands to and receive encoder signals from an actuator 612. In some cases, the motor drivers 610 may be Elmo amplifiers (Elmo Motion Control Ltd., Petach Tikva, Israel) for motor control. The motor drivers 610 may issue position commands to the actuator 612 at a rate of 10 kHz. The encoder 226 in the actuator 612 may output signals at a rate of 500-4 kHz, depending on the maneuvers being performed.

The control system may also include a fan 614 that receives motor commands through a fan controller 616. The fan controller 616 may regulate the speed and operation of the fan 614, which may be part of the thruster assembly 102.

An inertial measurement unit 618 may communicate with a processor 620 using SPI protocol. In some cases, the inertial measurement unit 618 may be a Sparkfun ICM20948 (SparkFun Electronics, Niwot, Colorado). The inertial measurement unit 618 may provide data on the orientation and acceleration of the bipedal robot 100, which may be crucial for maintaining balance and stability during locomotion.

The processor 620 may coordinate the communication between components through EtherCAT and manage the PWM signals sent to the fan controller 616. The processor 620 may execute instructions to generate walking trajectories for the leg assembly 104, control the actuators 612 to move the joints according to the walking trajectories, and control the thruster assembly 102 to assist with stabilization and obstacle traversal.

The motor drivers 610 may interface with both the actuator 612 and the processor 620 to enable coordinated control of the bipedal robot 100's movements. This arrangement may allow for precise control of the hip frontal joint, hip sagittal joint, and knee joint 220 in each leg of the leg assembly 104.

The control system architecture may enable the bipedal robot 100 to perform complex movements by coordinating the actions of the leg assembly 104 and the thruster assembly 102. The use of EtherCAT as the primary communication protocol between the controllers may ensure fast and reliable data transfer, while TCP/IP handles communication with the external PC 602, and SPI protocol enables communication with the inertial measurement unit 618.

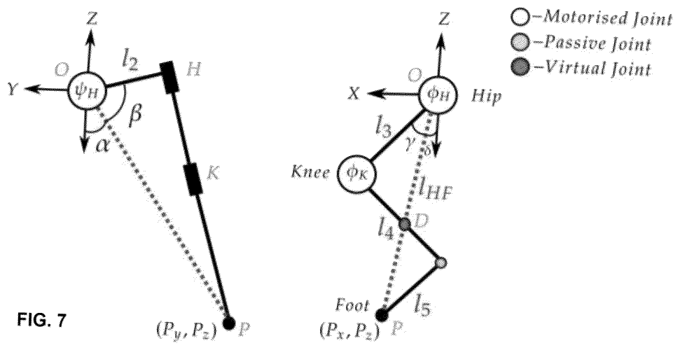

FIG. 7 illustrates a kinematic diagram of a robotic leg system for the bipedal robot 100. The diagram depicts the geometric relationships between different leg segments and their associated joints in both frontal and sagittal plane views.

The leg assembly 104 comprises several links: an upper leg link 12, a thigh link 13, a shin link 14, and a foot link 15. These links are connected through a series of joints represented by circles in the diagram. White circles indicate motorized joints, green circles indicate passive joints, and red circles indicate virtual joints.

In the frontal plane view (left side of FIG. 7), the upper leg link 12 extends from point O to points H and K, forming angles a and B with the vertical axis Z. The Y axis represents the lateral direction.

In the sagittal plane view (right side of FIG. 7), the thigh link 13 connects to the shin link 14, which in turn connects to the foot link 15. The X axis represents the forward direction. The links form a kinematic chain from the hip joint through the knee joint 220 to the foot point P, with coordinates (Px, Pz) in the sagittal plane and (Py, Pz) in the frontal planc.

The arrangement of the links and joints in this configuration enables the leg assembly 104 to perform controlled movements in both the frontal and sagittal planes while maintaining structural stability. This kinematic structure allows for the generation of complex walking trajectories and the adaptation to various terrains.

In some cases, the controller of the bipedal robot 100 may generate bezier curves to define trajectories for the hip frontal joint, hip sagittal joint, and knee joint 220 of each leg. The method of generating bezier curves may include defining control points for start and end positions of each joint trajectory. Additionally, the method may include calculating intermediate points to create smooth transitions between joint positions.

The use of bezier curves for trajectory generation may allow for precise control of the leg movements, enabling the bipedal robot 100 to perform smooth and natural-looking walking motions. The ability to define control points and calculate intermediate points may provide flexibility in adjusting the gait pattern to different walking speeds or terrain conditions.

By combining the kinematic structure illustrated in FIG. 7 with the bezier curve trajectory generation, the leg assembly 104 of the bipedal robot 100 may achieve a wide range of motion capabilities. This may enable the bipedal robot 100 to navigate complex environments and adapt to various locomotion challenges, working in conjunction with the thruster assembly 102 for enhanced stability and obstacle traversal.

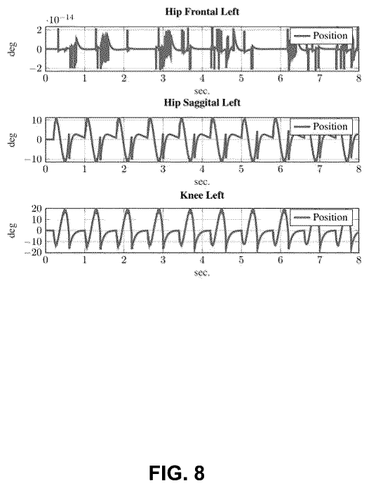

FIG. 8 illustrates three time-series graphs showing joint angle positions for the left leg of the bipedal robot over an 8-second duration. The graphs depict the movements of the hip frontal joint, hip sagittal joint, and knee joint during a walking gait.

The top graph in FIG. 8 displays the hip frontal joint position. This joint exhibits small oscillations between approximately −2 and 2 degrees with intermittent spikes. The relatively small range of motion in the frontal plane suggests that the hip frontal joint may primarily contribute to maintaining lateral balance during the walking gait.

The middle graph in FIG. 8 illustrates the hip sagittal joint position. This joint demonstrates regular cyclic motion between −10 and 10 degrees. The smooth, sinusoidal pattern indicates that the hip sagittal joint may be responsible for the forward and backward swinging motion of the leg during walking.

The bottom graph in FIG. 8 shows the knee joint position. This joint exhibits periodic movement patterns ranging from −20 to 20 degrees. The larger range of motion compared to the hip joints suggests that the knee joint may play a significant role in providing ground clearance during the swing phase and absorbing impact during the stance phase of the gait cycle.

The cyclic nature of all three joint movements indicates a repetitive walking pattern. The hip sagittal and knee joint motions appear to be closely coordinated, with their peaks and troughs occurring at similar intervals. This coordination may contribute to a smooth and efficient walking gait.

In some cases, the relatively small movements of the hip frontal joint may help maintain balance and stability during walking. The larger movements of the hip sagittal and knee joints may drive the primary forward motion of the bipedal robot.

The periodic patterns observed in these joint angles may be generated by the controller using bezier curves or other trajectory planning methods. The smooth transitions between joint positions may contribute to natural-looking and energy-efficient locomotion for the bipedal robot.

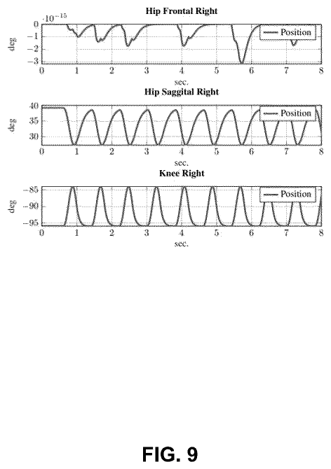

FIG. 9 illustrates three time-series graphs showing joint angle positions for the right leg of the bipedal robot over an 8-second duration. The graphs depict the movements of the hip frontal joint, hip sagittal joint, and knee joint during a walking gait.

The top graph in FIG. 9 displays the hip frontal joint position for the right leg. This joint exhibits small oscillations between approximately 0 and −3 degrees. Compared to the left leg's hip frontal joint, the right leg shows a slightly smaller range of motion and a negative offset. This difference may contribute to maintaining lateral balance during the walking gait and may compensate for any asymmetry in the robot's structure or weight distribution.

The middle graph in FIG. 9 illustrates the hip sagittal joint position for the right leg. This joint demonstrates regular cyclic motion between approximately 28 and 40 degrees. In contrast to the left leg's hip sagittal joint, which oscillated between −10 and 10 degrees, the right leg's motion is shifted to a higher positive range. This difference in range may indicate that the right leg may be in a different phase of the gait cycle compared to the left leg, possibly representing the stance phase while the left leg may be in the swing phase.

The bottom graph in FIG. 9 shows the knee joint position for the right leg. This joint exhibits periodic movement patterns ranging from approximately −85 to −95 degrees. The range of motion for the right knee joint may be significantly different from that of the left knee joint, which moved between −20 and 20 degrees. This substantial difference in knee joint angles between the left and right legs may suggest that the legs may be performing different functions during the observed gait cycle, with the right leg possibly providing support during the stance phase while the left leg may be in the swing phase.

The cyclic nature of all three joint movements in the right leg, similar to the left leg, may indicate a repetitive walking pattern. However, the differences in ranges and offsets between the left and right leg joint angles may suggest an asymmetric gait pattern. This asymmetry may be intentional, possibly designed to provide stability or to accommodate specific terrain conditions.

In some cases, the differences observed between the left and right leg joint angles may be part of a complex gait strategy implemented by the bipedal robot's controller. The asymmetric patterns may allow for more adaptable and stable locomotion, especially when combined with the thruster-assisted capabilities of the robot.

The periodic patterns observed in these joint angles may be generated by the controller using bezier curves or other trajectory planning methods, similar to the left leg. The smooth transitions between joint positions, despite the differences in ranges, may contribute to a coordinated and efficient locomotion strategy for the bipedal robot.

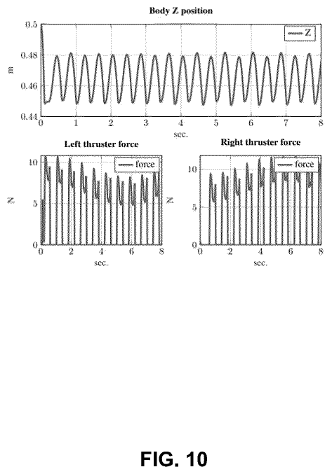

FIG. 10 illustrates three time-series graphs showing the vertical body position and thruster forces of the bipedal robot over an 8-second duration. The graphs depict the vertical motion of the robot's body and the force output from the left and right thrusters during a walking gait.

The top graph in FIG. 10 displays the body Z position, showing regular oscillatory motion between approximately 0.44 and 0.48 meters. This periodic vertical movement may correspond to the robot's gait cycle, with the body rising and falling as it shifts weight between legs during walking. The smooth, sinusoidal pattern of the body position may indicate a stable and controlled walking motion.

The bottom left graph in FIG. 10 illustrates the left thruster force output. This graph exhibits periodic pulses ranging from 0 to 10 Newtons. The pulses may occur at regular intervals, possibly corresponding to specific phases of the gait cycle. In some cases, these thruster pulses may provide additional stability or assist with weight shifting during the walking motion.

The bottom right graph in FIG. 10 shows the right thruster force output. Similar to the left thruster, this graph demonstrates periodic pulses ranging from 0 to 10 Newtons. The pulses from the right thruster may be coordinated with those from the left thruster to maintain balance and stability during locomotion.

In some cases, the periodic nature of the thruster forces may be synchronized with the oscillatory motion of the body position. This coordination may contribute to the overall stability of the bipedal robot during walking. The thrusters may provide additional support or compensate for imbalances at specific points in the gait cycle.

The relatively small magnitude of the thruster forces (up to 10 Newtons) may suggest that the thrusters may be used primarily for fine adjustments and stability control rather than providing the main propulsive force for locomotion. In some cases, this thruster assistance may allow the bipedal robot to maintain balance on uneven terrain or recover from minor disturbances during walking.

The consistent patterns observed in both the body position and thruster forces may indicate a well-controlled and stable walking gait. The smooth oscillations in body height, combined with the periodic thruster pulses, may contribute to efficient and adaptable locomotion for the bipedal robot.

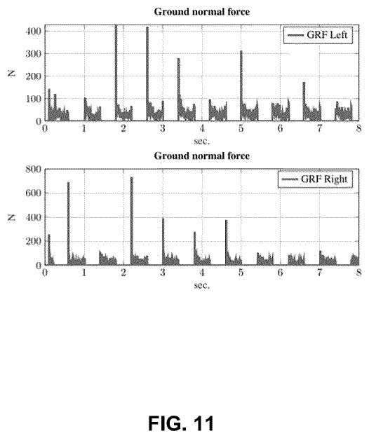

FIG. 11 depicts two time-series graphs showing ground normal force measurements for the left and right legs of the bipedal robot over an 8-second duration.

The top graph in FIG. 11 displays the ground reaction force (GRF) for the left leg. This graph shows periodic spikes reaching up to approximately 400 Newtons with baseline forces around 50 Newtons. The periodic nature of these spikes may correspond to the gait cycle of the bipedal robot, with each spike potentially representing the moment when the left foot contacts the ground during the stance phase.

The bottom graph in FIG. 11 illustrates the ground reaction force for the right leg. This graph exhibits larger periodic spikes reaching up to approximately 700 Newtons with similar baseline forces around 50 Newtons. The higher peak forces in the right leg compared to the left leg may indicate an asymmetry in the robot's gait or weight distribution.

In some cases, the difference in peak forces between the left and right legs may be intentional, possibly designed to provide enhanced stability during locomotion. The alternating pattern of force spikes between the left and right legs may represent the transfer of weight from one leg to the other during the walking gait.

The baseline force of around 50 Newtons observed in both legs may represent the constant load-bearing required to support the robot's weight, even when a leg may not be in full contact with the ground. The periodic spikes above this baseline may correspond to the additional forces generated during the push-off phase of each step.

In some cases, the bipedal robot may use inertial measurement unit (IMU) data to monitor and adjust its gait for optimal stability. The IMU data may be filtered to obtain pitch and roll angles of the robot. A low-pass filter and exponential moving average may be applied to process the IMU data, reducing noise and providing smoother angle measurements.

The filtered pitch and roll angle data may be used to generate capture point coordinates for foot placement. In some cases, the capture point coordinates may be generated when the pitch or roll angles exceed a predetermined threshold. This approach may allow the bipedal robot to make real-time adjustments to its gait in response to changes in its orientation, potentially improving stability and reducing the risk of falls.

The ground reaction force patterns observed in FIG. 11, combined with the processed IMU data, may provide valuable information for the bipedal robot's control system. This information may be used to adjust the robot's gait, thruster activation, and foot placement strategies to maintain balance and stability during locomotion across various terrains.

A number of implementations have been described. Nevertheless, it will be understood that various modifications may be made without departing from the spirit and scope of the disclosure. Accordingly, other implementations are within the scope of the following claims.

1. A bipedal robot, comprising:
a legged assembly, each leg having a hip frontal joint, a hip sagittal joint, and a knee joint;
an aerial assembly including two thrusters mounted on a composite mount;
actuators for the joints, the actuators including 3D printed housings with embedded components; and
a controller generating walking trajectories and controlling the thrusters to assist with stabilization and obstacle traversal.

2. The bipedal robot of claim 1, the composite mount comprising a carbon fiber-aluminum composite plate.

3. The bipedal robot of claim 1, each leg further comprising an ankle joint with a shock absorber assembly.

4. The bipedal robot of claim 3, the shock absorber assembly comprising a spring, a nut, and a housing reinforced with Kevlar.

5. The bipedal robot of claim 1, the actuators comprising:
a motor assembly including a brushless DC motor and an encoder; and
a harmonic drive assembly.

6. The bipedal robot of claim 5, the 3D printed housings comprising embedded bearings and heat-set inserts.

7. The bipedal robot of claim 1, the controller implementing a capture point algorithm to generate foot placement coordinates based on pitch and roll angles of the robot.

8. A method of operating a bipedal robot, comprising:
generating walking trajectories for each leg of the robot, each leg having a hip frontal joint, a hip sagittal joint, and a knee joint;
actuating the joints using actuators with 3D printed housings and embedded components; and
controlling two thrusters mounted on a composite mount to assist with stabilization and obstacle traversal.

9. The method of claim 8, further comprising:
generating capture point coordinates based on pitch and roll angles of the robot; and
adjusting foot placement of the legs based on the capture point coordinates.

10. The method of claim 9, further comprising:
filtering inertial measurement unit data to obtain the pitch and roll angles; and
generating the capture point coordinates when the pitch or roll angles exceed a predetermined threshold.

11. The method of claim 8, further comprising:
generating bezier curves to define trajectories for the hip frontal joint, hip sagittal joint, and knee joint of each leg.

12. The method of claim 11, wherein generating the bezier curves comprises:
defining control points for start and end positions of each joint trajectory; and
calculating intermediate points to create smooth transitions between joint positions.

13. The method of claim 8, further comprising:
activating shock absorbers in ankle joints of the legs to absorb impact forces during locomotion.

14. The method of claim 13, wherein activating the shock absorbers comprises:
compressing springs within housings reinforced with Kevlar; and
adjusting compression of the springs using threaded nuts to modify shock absorption characteristics.

15. A control system for a bipedal robot, comprising:
a processor executing instructions to:
generate walking trajectories for each leg of the robot, each leg having a hip frontal joint, a hip sagittal joint, and a knee joint;
control actuators with 3D printed housings and embedded components to move the joints according to the walking trajectories; and
control two thrusters mounted on a composite mount to assist with stabilization and obstacle traversal.

16. The control system of claim 15, wherein the processor executes instructions to:
generate capture point coordinates based on pitch and roll angles of the robot; and
adjust foot placement of the legs based on the capture point coordinates.

17. The control system of claim 16, wherein the processor executes instructions to:
filter inertial measurement unit data to obtain the pitch and roll angles; and
generate the capture point coordinates when the pitch or roll angles exceed a predetermined threshold.

18. The control system of claim 15, wherein the processor executes instructions to:
generate bezier curves defining trajectories for the hip frontal joint, hip sagittal joint, and knee joint of each leg.

19. The control system of claim 18, wherein generating the bezier curves comprises:
defining control points for start and end positions of each joint trajectory; and
calculating intermediate points to create smooth transitions between joint positions.

20. The control system of claim 15, wherein the processor executes instructions to:
activate shock absorbers in ankle joints of the legs to absorb impact forces during locomotion by compressing springs within housings reinforced with Kevlar; and
adjust compression of the springs using threaded nuts to modify shock absorption characteristics.
